(19) United States
(12) Patent Application Publication
(10) Pub. No.: US 2025/0111011 A1
(43) Pub. Date: Apr. 3, 2025

(54) Method, System, and Computer Program Product for Coordinated Analysis of Output Scores and Input Features of Machine Learning Models in Different Environments

(71) Applicant: Visa International Service Association, San Francisco, CA (US)

(72) Inventors: Junpeng Wang, Santa Clara, CA (US); Minghua Xu, Austin, TX (US); Shubham Jain, Mountain View, CA (US); Yan Zheng, Los Gatos, CA (US); Michael Yeh, Newark, CA (US); Liang Wang, San Jose, CA (US); Wei Zhang, Fremont, CA (US)

(21) Appl. No.: 18/374,799

(22) Filed: Sep. 29, 2023

(51) Int. Cl. G06F 17/18

(52) U.S. Cl. CPC G06F 17/18

(57) ABSTRACT

Methods, systems, and computer program products are provided for coordinated analysis of output scores and input features of machine learning models in different environments. An example method includes receiving a plurality of first data records and a plurality of second data records. A first plot is generated based on a first score generated by a machine learning model for each first data record and a second score generated by the machine learning model for each second data record. The first plot is displayed. A plurality of second plots associated with at least a subset of the plurality of features are generated. Each respective second plot is generated based on a respective first field associated with a respective feature from the first data records and a respective second field associated with the respective feature from the second data records. The second plots are displayed.

### BACKGROUND

### 1. Field

This disclosure relates generally to analysis of machine learning models in different environments and, in some non-limiting embodiments or aspects, to methods, systems, and computer program products for coordinated analysis of output scores and input features of machine learning models in different environments.

### 2. Technical Considerations

Machine learning models can be trained to generate certain outputs based on datasets (e.g., historical datasets including a plurality of historical data records). For example, a machine learning model can be configured (e.g., designed) to receive input data in a certain format and to generate an output based on the input data. When the input data is accurate and formatted properly, the machine learning model may achieve a desirable level of performance (e.g., accuracy).

However, performance of a machine learning model can change (e.g., decrease, become less accurate, and/or the like) when the machine learning model that was trained in one environment is deployed in another environment. For example, in a training environment, datasets used for training the machine learning model may be formatted in a certain way, but once the trained machine learning model is deployed into a different environment, the input data may be inadvertently formatted at least partially differently, which may affect performance of the machine learning model. Additionally, datasets used in the training environment may be accurate, but incoming data (e.g., real time data) received in the different environment after deployment of the trained machine learning model may contain inaccuracies, which may affect performance of the machine learning model. Small mismatches in raw data may sometimes result in large differences in formatted input features for the machine learning model and/or large differences in the output generated by the machine learning model. However, it can be difficult to determine which mismatches contribute to the change in performance of the machine learning model and/or how much each mismatch contributes to the change in performance of the machine learning model.

### SUMMARY

Accordingly, it is an object of the present disclosure to provide methods, systems, and computer program products for coordinated analysis of output scores and input features of machine learning models in different environments (e.g., that overcome some or all of the deficiencies identified above).

According to non-limiting embodiments or aspects, provided is a computer-implemented method for coordinated analysis of output scores and input features of machine learning models in different environments. An example method may include receiving a plurality of first data records. Each first data record may include a plurality of first fields associated with a plurality of features and a first score field associated with a first score generated by a machine learning model based on the plurality of first fields. A plurality of second data records may be received. Each second data record may include a plurality of second fields associated with the plurality of features and a second score field associated with a second score generated by the machine learning model based on the plurality of second fields. A first plot may be generated based on the first score for each first data record of the plurality of first data records and the second score for each second data record of the plurality of second data records. The first plot may be displayed. A plurality of second plots associated with at least a subset of the plurality of features may be generated. Each respective second plot may be generated based on a respective first field of the plurality of first fields associated with a respective feature of the plurality of features and a respective second field of the plurality of second fields associated with the respective feature. The plurality of second plots may be displayed.

In some non-limiting embodiments or aspects, the plurality of features may be ranked based on at least one mismatch metric determined based on the respective first field associated with each respective feature and the respective second field associated with each respective feature. Generating the plurality of second plots may include generating the plurality of second plots associated with a selected number of the plurality of features based on the ranking of the plurality of features. Displaying the plurality of second plots may include displaying the plurality of second plots in order based on the ranking of the plurality of features.

In some non-limiting embodiments or aspects, the at least one mismatch metric may include at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

In some non-limiting embodiments or aspects, the at least one metric may include the Pearson correlation metric. Ranking the plurality of features may include determining a first difference based on the first score for each first data record and the second score for each second data record, determining a plurality of second differences including a respective second difference based on the respective first field associated with each respective feature and the respective second field associated with each respective feature, and/or determining the Pearson correlation metric for each respective feature based on the first difference and the respective second difference.

In some non-limiting embodiments or aspects, ranking the plurality of features may include determining a first difference based on the first score for each first data record and the second score for each second data record, determining a plurality of second differences including a respective second difference based on the respective first field associated with each respective feature and the respective second field associated with each respective feature, and/or regressing the first difference onto the plurality of second differences based on the at least one decision tree model to provide at least one of the gain metric, the weight metric, the cover metric, the SHAP metric, or any combination thereof.

In some non-limiting embodiments or aspects, a selection of a first point in the first plot associated with a respective first data record of the plurality of first data records and a respective second data record of the plurality of second data records may be received. A respective second point in each second plot of the plurality of second plots associated with the respective first data record and the respective second data record may be automatically selected.

In some non-limiting embodiments or aspects, a selection of a second point in one of the plurality of second plots associated with a respective first data record of the plurality of first data records and a respective second data record of the plurality of second data records may be received. A first point in the first plot associated with the respective first data record and the respective second data record may be automatically selected. Additionally or alternatively, a respective second point associated with the respective first data record and the respective second data record in each second plot of the plurality of second plots other than the one of the plurality of second plots may be automatically selected.

In some non-limiting embodiments or aspects, the first plot may include a first scatterplot and the plurality of second plots may include a plurality of second scatterplots. In some non-limiting embodiments or aspects, the first scatterplot may be converted to a first density plot. Additionally or alternatively, the plurality of second scatterplots may be converted to a plurality of second density plots. The first density plot may be displayed, and/or the plurality of second density plots may be displayed.

In some non-limiting embodiments or aspects, a plurality of first points of the first plot may be indexed based on a first quadtree data structure. Additionally or alternatively, a respective plurality of second points of each respective second plot of the plurality of second plots may be indexed based on a respective second quadtree data structure.

In some non-limiting embodiments or aspects, the plurality of first data records may be from a first environment. The plurality of second data records may be from a second environment different than the first environment. Each respective first data record of the plurality of first data records may have a corresponding second data record of the plurality of second data records.

In some non-limiting embodiments or aspects, the first environment may include an offline environment, and/or the second environment may include an online environment.

According to non-limiting embodiments or aspects, provided is a system for coordinated analysis of output scores and input features of machine learning models in different environments. An example system may include at least one processor and at least one non-transitory computer readable medium comprising one or more instructions. When executed by the at least one processor, the instructions may cause the at least one processor to receive a plurality of first data records. Each first data record of the plurality of first data records may include a plurality of first fields associated with a plurality of features and a first score field associated with a first score generated by a machine learning model based on the plurality of first fields. When executed by the at least one processor, the instructions may cause the at least one processor to receive a plurality of second data records. Each second data record of the plurality of second data records may include a plurality of second fields associated with the plurality of features and a second score field associated with a second score generated by the machine learning model based on the plurality of second fields. When executed by the at least one processor, the instructions may cause the at least one processor to generate a first plot based on the first score for each first data record of the plurality of first data records and the seconds score for each second data record of the plurality of second data records. When executed by the at least one processor, the instructions may cause the at least one processor to display the first plot. When executed by the at least one processor, the instructions may cause the at least one processor to generate a plurality of second plots associated with at least a subset of the plurality of features. Each respective second plot of the plurality of second plots may be generated based on a respective first field of the plurality of first fields associated with a respective feature of the plurality of features and a respective second field of the plurality of second fields associated with the respective feature. When executed by the at least one processor, the instructions may cause the at least one processor to display the plurality of second plots.

In some non-limiting embodiments or aspects, the one or more instructions, when executed by the at least one processor, may cause the at least one processor to rank the plurality of features based on at least one mismatch metric determined based on the respective first field associated with each respective feature and the respective second field associated with each respective feature. Generating the plurality of second plots may include generating the plurality of second plots associated with a selected number of the plurality of features based on the ranking of the plurality of features. Displaying the plurality of second plots may include displaying the plurality of second plots in order based on the ranking of the plurality of features.

In some non-limiting embodiments or aspects, the at least one mismatch metric may include at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

In some non-limiting embodiments or aspects, the at least one metric may include the Pearson correlation metric. Ranking the plurality of features may include determining a first difference based on the first score for each first data record and the second score for each second data record, determining a plurality of second differences including a respective second difference based on the respective first field associated with each respective feature and the respective second field associated with each respective feature, and/or determining the Pearson correlation metric for each respective feature based on the first difference and the respective second difference.

In some non-limiting embodiments or aspects, ranking the plurality of features may include determining a first difference based on the first score for each first data record and the second score for each second data record, determining a plurality of second differences including a respective second difference based on the respective first field associated with each respective feature and the respective second field associated with each respective feature, and/or regressing the first difference onto the plurality of second differences based on the at least one decision tree model to provide at least one of the gain metric, the weight metric, the cover metric, the SHAP metric, or any combination thereof.

In some non-limiting embodiments or aspects, the one or more instructions, when executed by the at least one processor, may cause the at least one processor to receive a selection of a first point in the first plot associated with a respective first data record of the plurality of first data records and a respective second data record of the plurality of second data records and/or automatically select a respective second point in each second plot of the plurality of second plots associated with the respective first data record and the respective second data record.

In some non-limiting embodiments or aspects, the one or more instructions, when executed by the at least one processor, may cause the at least one processor to receive a selection of a second point in one of the plurality of second plots associated with a respective first data record of the plurality of first data records and a respective second data record of the plurality of second data records, automatically select a first point in the first plot associated with the respective first data record and the respective second data record, and/or automatically select a respective second point associated with the respective first data record and the respective second data record in each second plot of the plurality of second plots other than the one of the plurality of second plots.

In some non-limiting embodiments or aspects, the plurality of first data records may be from a first environment, and/or the plurality of second data records may be from a second environment different than the first environment. Each respective first data record of the plurality of first data records may have a corresponding second data record of the plurality of second data records.

In some non-limiting embodiments or aspects, the first environment may include an offline environment and the second environment may include an online environment.

According to non-limiting embodiments or aspects, provided is a computer program product, the computer program product comprising at least one non-transitory computer-readable medium comprising one or more instructions that, when executed by at least one processor, cause the at least one processor to perform any of the methods described herein. For example, a plurality of first data records may be received. Each first data record of the plurality of first data records may include a plurality of first fields associated with a plurality of features and a first score field associated with a first score generated by a machine learning model based on the plurality of first fields. A plurality of second data records may be received. Each second data record of the plurality of second data records may include a plurality of second fields associated with the plurality of features and a second score field associated with a second score generated by the machine learning model based on the plurality of second fields. A first plot may be generated based on the first score for each first data record of the plurality of first data records and the seconds score for each second data record of the plurality of second data records. The first plot may be displayed. A plurality of second plots associated with at least a subset of the plurality of features may be generated. Each respective second plot of the plurality of second plots may be generated based on a respective first field of the plurality of first fields associated with a respective feature of the plurality of features and a respective second field of the plurality of second fields associated with the respective feature. The plurality of second plots may be displayed.

Further non-limiting embodiments or aspects will be set forth in the following numbered clauses:

Clause 1: A computer-implemented method for coordinated analysis of output scores and input features of machine learning models in different environments, comprising: receiving, with at least one processor, a plurality of first data records, each first data record of the plurality of first data records comprising a plurality of first fields associated with a plurality of features and a first score field associated with a first score generated by a machine learning model based on the plurality of first fields; receiving, with at least one processor, a plurality of second data records, each second data record of the plurality of second data records comprising a plurality of second fields associated with the plurality of features and a second score field associated with a second score generated by the machine learning model based on the plurality of second fields; generating, with at least one processor, a first plot based on the first score for each first data record of the plurality of first data records and the second score for each second data record of the plurality of second data records; displaying, with at least one processor, the first plot; generating, with at least one processor, a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and displaying, with at least one processor, the plurality of second plots.

Clause 2: The method of clause 1, further comprising: ranking, with at least one processor, the plurality of features based on at least one mismatch metric determined based on the respective first field associated with each respective feature and the respective second field associated with each respective feature, wherein generating the plurality of second plots comprises generating the plurality of second plots associated with a selected number of the plurality of features based on the ranking of the plurality of features, and wherein displaying the plurality of second plots comprises displaying the plurality of second plots in order based on the ranking of the plurality of features.

Clause 3: The method of clause 1 or clause 2, wherein the at least one mismatch metric comprises at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

Clause 4: The method of any of clauses 1-3, wherein the at least one metric comprises the Pearson correlation metric, and wherein ranking the plurality of features comprises: determining a first difference based on the first score for each first data record and the second score for each second data record; determining a plurality of second differences comprising a respective second difference based on the respective first field associated with each respective feature and the respective second field associated with each respective feature; and determining the Pearson correlation metric for each respective feature based on the first difference and the respective second difference.

Clause 5: The method of any of clauses 1-4, wherein ranking the plurality of features comprises: determining a first difference based on the first score for each first data record and the second score for each second data record; determining a plurality of second differences comprising a respective second difference based on the respective first field associated with each respective feature and the respective second field associated with each respective feature; and regressing the first difference onto the plurality of second differences based on the at least one decision tree model to provide at least one of the gain metric, the weight metric, the cover metric, the SHAP metric, or any combination thereof.

Clause 6: The method of any of clauses 1-5, further comprising: receiving, with at least one processor, a selection of a first point in the first plot associated with a respective first data record of the plurality of first data records and a respective second data record of the plurality of second data records; and automatically selecting, with at least one processor, a respective second point in each second plot of the plurality of second plots associated with the respective first data record and the respective second data record.

Clause 7: The method of any of clauses 1-6, further comprising: receiving, with at least one processor, a selection of a second point in one of the plurality of second plots associated with a respective first data record of the plurality of first data records and a respective second data record of the plurality of second data records; automatically selecting, with at least one processor, a first point in the first plot associated with the respective first data record and the respective second data record; and automatically selecting, with at least one processor, a respective second point associated with the respective first data record and the respective second data record in each second plot of the plurality of second plots other than the one of the plurality of second plots.

Clause 8: The method of any of clauses 1-7, wherein the first plot comprises a first scatterplot and the plurality of second plots comprises a plurality of second scatterplots, the method further comprising: converting, with at least one processor, the first scatterplot to a first density plot; converting, with at least one processor, the plurality of second scatterplots to a plurality of second density plots; displaying, with at least one processor, the first density plot; and displaying, with at least one processor, the plurality of second density plots.

Clause 9: The method of any of clauses 1-8, further comprising: indexing, with at least one processor, a plurality of first points of the first plot based on a first quadtree data structure; and indexing, with at least one processor, a respective plurality of second points of each respective second plot of the plurality of second plots based on a respective second quadtree data structure.

Clause 10: The method of any of clauses 1-9, wherein the plurality of first data records are from a first environment, wherein the plurality of second data records are from a second environment different than the first environment, and wherein each respective first data record of the plurality of first data records has a corresponding second data record of the plurality of second data records.

Clause 11: The method of any of clauses 1-10, wherein the first environment comprises an offline environment, and wherein the second environment comprises an online environment.

Clause 12: A system for coordinated analysis of output scores and input features of machine learning models in different environments, comprising: at least one processor; and at least one non-transitory computer readable medium comprising one or more instructions that, when executed by the at least one processor, cause the at least one processor to: receive a plurality of first data records, each first data record of the plurality of first data records comprising a plurality of first fields associated with a plurality of features and a first score field associated with a first score generated by a machine learning model based on the plurality of first fields; receive a plurality of second data records, each second data record of the plurality of second data records comprising a plurality of second fields associated with the plurality of features and a second score field associated with a second score generated by the machine learning model based on the plurality of second fields; generate a first plot based on the first score for each first data record of the plurality of first data records and the seconds score for each second data record of the plurality of second data records; display the first plot; generate a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and display the plurality of second plots.

Clause 13: The system of clause 12, wherein the one or more instructions, when executed by the at least one processor, cause the at least one processor to: rank the plurality of features based on at least one mismatch metric determined based on the respective first field associated with each respective feature and the respective second field associated with each respective feature, wherein generating the plurality of second plots comprises generating the plurality of second plots associated with a selected number of the plurality of features based on the ranking of the plurality of features, and wherein displaying the plurality of second plots comprises displaying the plurality of second plots in order based on the ranking of the plurality of features.

Clause 14: The system of clause 12 or clause 13, wherein the at least one mismatch metric comprises at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

Clause 15: The system of any of clauses 12-14, wherein the at least one metric comprises the Pearson correlation metric, and wherein ranking the plurality of features comprises: determining a first difference based on the first score for each first data record and the second score for each second data record; determining a plurality of second differences comprising a respective second difference based on the respective first field associated with each respective feature and the respective second field associated with each respective feature; and determining the Pearson correlation metric for each respective feature based on the first difference and the respective second difference.

Clause 16: The system of any of clauses 12-15, wherein ranking the plurality of features comprises: determining a first difference based on the first score for each first data record and the second score for each second data record; determining a plurality of second differences comprising a respective second difference based on the respective first field associated with each respective feature and the respective second field associated with each respective feature; and regressing the first difference onto the plurality of second differences based on the at least one decision tree model to provide at least one of the gain metric, the weight metric, the cover metric, the SHAP metric, or any combination thereof.

Clause 17: The system of any of clauses 12-16, wherein the one or more instructions, when executed by the at least one processor, cause the at least one processor to: receive a selection of a first point in the first plot associated with a respective first data record of the plurality of first data records and a respective second data record of the plurality of second data records; and automatically select a respective second point in each second plot of the plurality of second plots associated with the respective first data record and the respective second data record.

Clause 18: The system of any of clauses 12-17, wherein the one or more instructions, when executed by the at least one processor, cause the at least one processor to: receive a selection of a second point in one of the plurality of second plots associated with a respective first data record of the plurality of first data records and a respective second data record of the plurality of second data records; automatically select a first point in the first plot associated with the respective first data record and the respective second data record; and automatically select a respective second point associated with the respective first data record and the respective second data record in each second plot of the plurality of second plots other than the one of the plurality of second plots.

Clause 19: The system of any of clauses 12-18, wherein the plurality of first data records are from a first environment, wherein the plurality of second data records are from a second environment different than the first environment, wherein each respective first data record of the plurality of first data records has a corresponding second data record of the plurality of second data records, and wherein the first environment comprises an offline environment and the second environment comprises an online environment.

Clause 20: A computer program product, the computer program product comprising at least one non-transitory computer-readable medium comprising one or more instructions that, when executed by at least one processor, cause the at least one processor to: receive a plurality of first data records, each first data record of the plurality of first data records comprising a plurality of first fields associated with a plurality of features and a first score field associated with a first score generated by a machine learning model based on the plurality of first fields; receive a plurality of second data records, each second data record of the plurality of second data records comprising a plurality of second fields associated with the plurality of features and a second score field associated with a second score generated by the machine learning model based on the plurality of second fields; generate a first plot based on the first score for each first data record of the plurality of first data records and the seconds score for each second data record of the plurality of second data records; display the first plot; generate a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and display the plurality of second plots.

Clause 21: A computer program product, the computer program product comprising at least one non-transitory computer-readable medium comprising one or more instructions that, when executed by at least one processor, cause the at least one processor to perform the method of any of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example system for coordinated analysis of output scores and input features of machine learning models in different environments, according to some non-limiting embodiments or aspects;

FIG. 2 is a flow diagram for an example process for coordinated analysis of output scores and input features of machine learning models in different environments, according to some non-limiting embodiments or aspects;

FIG. 3 is an example plot of output scores of a machine learning model in different environments, according to some non-limiting embodiments or aspects;

FIGS. 4A and 4B show example plots according to an example implementation of a process for coordinated analysis of output scores and input features of machine learning models in different environments, according to some non-limiting embodiments or aspects;

FIGS. 5A-5C show an example graphical user interface according to an example implementation of a process for coordinated analysis of output scores and input features of machine learning models in different environments, according to some non-limiting embodiments or aspects;

FIG. 6 shows an example quadtree according to an example implementation of a process for coordinated analysis of output scores and input features of machine learning models in different environments, according to some non-limiting embodiments or aspects;

FIGS. 7A and 7B show an example scatterplot and an example density plot, respectively, according to an example implementation of a process for coordinated analysis of output scores and input features of machine learning models in different environments, according to some non-limiting embodiments or aspects;

FIGS. 8A-8C show example scatterplots according to example implementations of a process for coordinated analysis of output scores and input features of machine learning models in different environments, according to some non-limiting embodiments or aspects;

FIG. 9 is a diagram of an example environment in which methods, systems, and/or computer program products, described herein, may be implemented, according to some non-limiting embodiments or aspects;

FIG. 10 is a schematic diagram of example components of a device used in connection with some non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and/or “client device” may refer to one or more client-side devices or systems (e.g., remote from a transaction service provider system) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for analysis of machine learning models in different environments, including, but not limited to, coordinated analysis of output scores and input features of machine learning models in different environments. For example, non-limiting embodiments or aspects of the disclosed subject matter provide receiving a plurality of first data records (e.g., a first dataset from a first environment, such as an offline environment), each including a plurality of first fields associated with a plurality of features and a first score field associated with a first score generated by a machine learning model based on the first fields, and receiving a plurality of second data records (e.g., a second dataset from a second environment, such as an online environment), each including a plurality of second fields associated with the (same) plurality of features and a second score field associated with a second score generated by the (same) machine learning model based on the second fields. For example, each respective first data record may have a corresponding second data record (e.g., representing the same thing, but with data from a different environment). A first plot may be generated based on the first score for each first data record and the second score for each second data record, and a plurality of second plots associated with at least a subset of the plurality of features may be generated (e.g., each respective second plot may be generated based on a respective first field associated with a respective feature and a respective second field of the plurality of second fields associated with the (same) respective feature). The first plot and the plurality of second plots may be displayed (e.g., simultaneously). As such, the disclosed subject matter allows for coordinated, synchronized analysis between the output scores of the machine learning model in different environments and the input features for the different environments. Additionally, non-limiting embodiments or aspects of the disclosed subject matter provide ranking the plurality of features based on at least one mismatch metric determined based on the respective first field associated with each respective feature and the respective second field associated with each respective feature, and the second plots may be generated and/or displayed based on the ranking (e.g., in order of greatest to least mismatch metric). By virtue of this ranking and display in order of ranking, relevant data records for which there is a significant amount of mismatch (and that likely contributed to the differences in behavior and/or performance of the machine learning model) can be efficiently identified and visualized. Moreover, non-limiting embodiments or aspects of the disclosed subject matter provide receiving a selection of one or more points in one of the displayed plots and automatically selecting (e.g., highlighting, changing color and/or shading, and/or the like) corresponding points (e.g., associated with the same data records) in each other plot. By virtue of this dynamic, coordinated selection, the mismatched input features that contribute to different machine learning model behavior and/or performance can be discovered. In addition, non-limiting embodiments or aspects of the disclosed subject matter provides indexing points of the plots based on quadtree data structures, which enables even more efficient automatic selection of the corresponding points in the different plots when a point is selected in one of the plots.

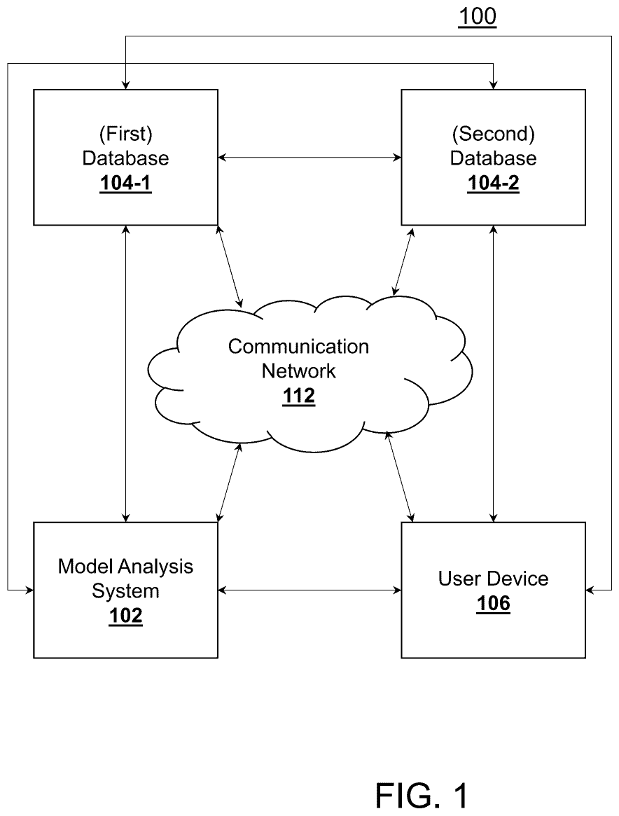

Referring now to FIG. 1, depicted is an example system 100 for coordinated analysis of output scores and input features of machine learning models in different environments, according to some non-limiting embodiments or aspects. For example, system 100 may include model analysis system 102, at least one database (e.g., first database 104-1 and second database 104-2, collectively referred to as “databases 104” and individually referred to as “database 104”), user device 106, and/or communication network 112.

Model analysis system 102 may include one or more devices capable of receiving information from and/or communicating information to database(s) 104 and/or user device 106 (e.g., directly via wired or wireless communication connection, indirectly via communication network 112, and/or the like). For example, model analysis system 102 may include a computing device, such as a server, a group of servers, a desktop computer, a portable computer, a mobile device, and/or other like devices. In some non-limiting embodiments or aspects, model analysis system 102 may be in communication with a data storage device (e.g., one or more databases 104), which may be local or remote to model analysis system 102. In some non-limiting embodiments or aspects, model analysis system 102 may be capable of receiving information from, storing information in, communicating information to, or searching information stored in the data storage device (e.g., one or more databases 104).

Each database 104 may include one or more devices capable of receiving information from and/or communicating information to model analysis system 102 and/or user device 106 (e.g., directly via wired or wireless communication connection, indirectly via communication network 112, and/or the like). For example, each database 104 may include a computing device, such as a server, a group of servers, a desktop computer, a portable computer, a mobile device, and/or other like devices. Additionally or alternatively, each user database 104 may include a device capable of receiving information from and/or communicating information to other user databases 104 (e.g., directly via wired or wireless communication connection, indirectly via communication network 112, and/or the like). In some non-limiting embodiments or aspects, each database 104 may include a data storage device. In some non-limiting embodiments or aspects, each database 104 may be capable of receiving information from, storing information in, communicating information to, or searching information stored in the data storage device. In some non-limiting embodiments or aspects, at least one database 104 may be part of model analysis system 102 and/or part of the same system as model analysis system 102.

In some non-limiting embodiments or aspects, system 100 may include at least two databases 104 storing data records from at least two environments. For example, first database 104-1 may store a plurality of first data records from a first environment (e.g., an offline environment, such as a development, training, and/or testing environment), as described herein. Additionally or alternatively, second database 104-2 may store a plurality of second data records from a second environment (e.g., an online environment, such as an inference-time environment, a runtime environment, an electronic payment processing network environment, and/or the like) different than the first environment, as described herein. In some non-limiting embodiments or aspects, each respective first data record of the plurality of first data records may have a corresponding second data record in the plurality of second data records, as described herein.

User device 106 may include one or more devices capable of receiving information from and/or communicating information to model analysis system 102 and/or database(s) 104 (e.g., directly via wired or wireless communication connection, indirectly via communication network 112, and/or the like). For example, user device 106 may include a computing device, such as a mobile device, a portable computer, a desktop computer, and/or other like devices. Additionally or alternatively, each user device 106 may include a device capable of receiving information from and/or communicating information to other user devices 106 (e.g., directly via wired or wireless communication connection, indirectly via communication network 112, and/or the like). In some non-limiting embodiments or aspects, user device 106 may be part of model analysis system 102 and/or part of the same system as model analysis system 102. For example, model analysis system 102, databases 104, and user device 106 may all be (and/or be part of) a single system and/or a single computing device.

Communication network 112 may include one or more wired and/or wireless networks. For example, communication network 112 may include a cellular network (e.g., a long-term evolution (LTE®) network, a third generation (5G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

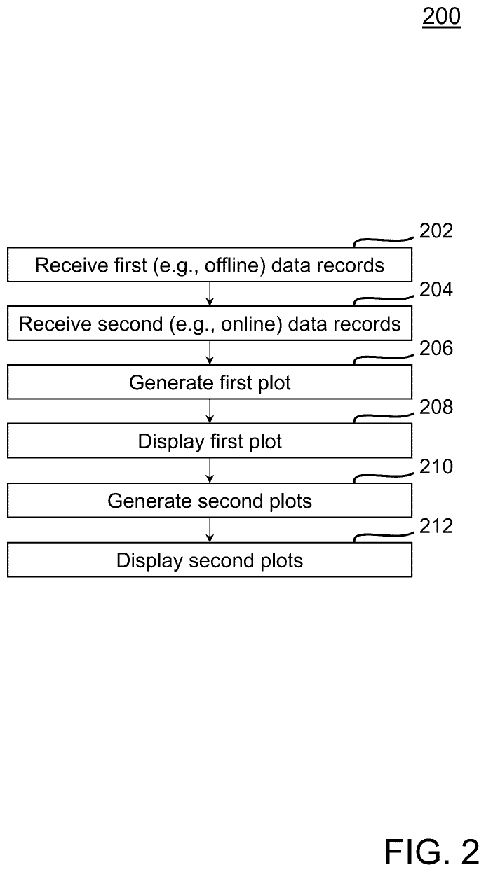

Referring now to FIG. 2, shown is a process 200 for coordinated analysis of output scores and input features of machine learning models in different environments, according to some non-limiting embodiments or aspects. The steps shown in FIG. 2 are for example purposes only. It will be appreciated that additional, fewer, different, and/or a different order of steps may be used in non-limiting embodiments or aspects. In some non-limiting embodiments or aspects, one or more of the steps of process 200 may be performed (e.g., completely, partially, and/or the like) by model analysis system 102 (e.g., one or more devices of model analysis system 102). In some non-limiting embodiments or aspects, one or more of the steps of process 200 may be performed (e.g., completely, partially, and/or the like) by another system, another device, another group of systems, or another group of devices, separate from or including model analysis system 102, such as database(s) 104 and/or user device 106.

As shown in FIG. 2, at step 202, process 200 may include receiving first data records. For example, model analysis system 102 may receive a plurality of first data records from database(s) 104 (e.g., from first database 104-1).

In some non-limiting embodiments or aspects, each first data record may include a plurality of first fields associated with a plurality of features and a first score field associated with a first score generated by a machine learning model based on the plurality of first fields.

In some non-limiting embodiments or aspects, the first data records may be from a first environment. For example, the first environment may include an offline environment. For the purpose of illustration, an offline environment may include at least one of a development environment, a training environment, a testing environment, any combination thereof, and/or the like.

In some non-limiting embodiments or aspects, first database 104-1 may be associated with the first environment. In some non-limiting embodiments or aspects, first database 104-1 may store first data records in a tabular format including a plurality of rows and a plurality of columns. Each row may be associated with (e.g., may represent) a respective first data record. Each column may be associated with a respective feature. Each row may include a plurality of first fields including a respective first field for each respective feature (e.g., a respective field for each column). For the purpose of illustration, Table 1 includes example data from a first (e.g., offline) environment:

TABLE 1

| | Feature 1 | Feature 2 | Feature 3 | |
|---|---|---|---|---|
| ID | (categorical) | (numerical) | (embedding) | score |
| 1 | 1 | 0.02 | 0.1235 | 0.2 |
| 2 | 1 | 0.4 | 0.3453 | 0.9 |
| 3 | 6 | 0.124 | 0.2356 | 0.5 |
| . . . | . . . | . . . | . . . | . . . |

As shown in Table 1, each first data record may include an identifier (ID) in an identifier field. Additionally, each data record may include a plurality of feature fields. For example, each feature may be of a respective type (e.g., categorical, numerical, embedding, and/or the like). In some non-limiting embodiments or aspects, there may be multiple feature fields of at least one type (e.g., multiple feature fields of each feature type). Each data record may also include a score field, which may include a score generated by the machine learning model based on the plurality of feature fields of that data record.

In some non-limiting embodiments or aspects, the machine learning model may be trained and/or tested in the first environment. For example, the machine learning model may be trained (e.g., by model analysis system 102 and/or at least one other computing device and/or system, which may be separate from or including model analysis system 102) by generating an output (e.g., score) for each first data record (or a subset thereof). For the purpose of illustration, the values of the feature fields of each first data record (or the subset thereof) may be inputted (e.g., by model analysis system 102 and/or the at least one other computing device/system) to the machine learning model to generate a respective output (e.g., score) for each respective first data record (e.g., by forward propagation and/or the like). A loss may be determined for each output (e.g., based on comparison to and/or a difference from a label and/or expected output/score, based on a loss function, based on an error calculation, and/or the like). In some non-limiting embodiments or aspects, the parameters (e.g., weights, connection values, and/or the like) of the machine learning model may be updated (e.g., adjusted) based on the loss (e.g., by back propagation, gradient calculations, and/or the like) (e.g., by model analysis system 102 and/or the at least one other computing device/system).

As shown in FIG. 2, at step 204, process 200 may include receiving second data records. For example, model analysis system 102 may receive a plurality of second data records from database(s) 104 (e.g., from second database 104-2).

In some non-limiting embodiments or aspects, each second data record of the plurality of second data records may include a plurality of second fields associated with the plurality of features (e.g., nominally the same plurality of features as with the first data records) and a second score field associated with a second score generated by the machine learning model (e.g., the same machine learning model as the first data records) based on the plurality of second fields.

In some non-limiting embodiments or aspects, the plurality of second data records may be from a second environment different than the first environment. For example, the second environment may include an online environment. For the purpose of illustration, an online environment may include at least one of an inference-time environment, a runtime environment, an electronic payment processing network environment, any combination thereof, and/or the like.

In some non-limiting embodiments or aspects, each respective first data record may have a corresponding second data record of the plurality of second data records. For example, the corresponding second data record may have an identifier (ID) that matches the ID of the respective first data record. In some non-limiting embodiments or aspects, the corresponding second data record may represent the same thing as the respective first data record, but the data (e.g., values of the feature fields) of the second data record may be from a different environment.

In some non-limiting embodiments or aspects, the second data records may be based on data received (e.g., in real time) in the second environment. For example, messages (e.g., data packets, transaction messages, authorization requests, authorization responses, settlement messages, clearing messages, and/or the like) including data (e.g., raw data) associated with the second data records may be received (e.g., by model analysis system 102 and/or at least one other computing device and/or system, which may be separate from or including model analysis system 102). In some non-limiting embodiments or aspects, values for each feature field of each second data record (e.g., values associated with each feature) may be determined (e.g., derived, calculated, aggregated, and/or the like) based on the (raw) data in the messages (e.g., by feature engineering and/or the like). In some non-limiting embodiments or aspects, the values for each feature field of each second data record may be intended to be the same as the corresponding feature field in the corresponding first data record. However, there may be inadvertent discrepancies between the first data record and the corresponding second data record. For example, numerical feature fields may be calculated with a different level of precision (e.g., a different number of significant digits, rounding to a different number of numerals after the decimal point, and/or the like). Additionally or alternatively, categorical feature fields may be different and/or incorrect in the second environment than the first environment. Additionally or alternatively, embedding feature fields (e.g., which may be determined based on the other feature fields and/or the raw data) may have a different value based on the variations in the other feature fields and/or in the raw data.

For the purpose of illustration, Table 2 includes example data from a second (e.g., online) environment:

TABLE 2

| | Feature 1 | Feature 2 | Feature 3 | |
|---|---|---|---|---|
| ID | (categorical) | (numerical) | (embedding) | score |
| 1 | 1 | 0.02 | 0.1235 | 0.2 |
| 2 | 1 | 0.41 | 0.3453 | 0.5 |
| 3 | 60 | 0.124 | 0.6234 | 0.1 |
| . . . | . . . | . . . | . . . | . . . |

As shown in Table 2, each second first data record may include an identifier (ID) in an identifier field. Additionally, each data record may include a plurality of feature fields. For example, each feature may be of a respective type (e.g., categorical, numerical, embedding, and/or the like). In some non-limiting embodiments or aspects, there may be multiple feature fields of at least one type (e.g., multiple feature fields of each feature type). Each data record may also include a score field, which may include a score generated by the machine learning model based on the plurality of feature fields of that data record.

As shown in FIG. 2, at step 206, process 200 may include generating a first plot. For example, model analysis system 102 may generate a first plot based on the first score for each first data record of the plurality of first data records and the second score for each second data record of the plurality of second data records.

In some non-limiting embodiments or aspects, the first plot may include a plurality of points (e.g., first points). For example, each respective point may be associated with a respective first data record and the corresponding second data record (e.g., the second data record having an identifier that matches the identifier of the respective first data record).

In some non-limiting embodiments or aspects, each respective point may have at least one coordinate based on the first score from the respective first data record and at least one coordinate based on the second score from the corresponding second data record. For example, the first plot may include a vertical axis associated with a first score (e.g., generated by the machine learning model based on the first data records and/or the first fields thereof from the first environment) and a horizontal axis associated with a second score (e.g., generated by the machine learning model based on the second data records and/or the second fields thereof from the second environment), as described herein. As such, each respective point of the plot may have a vertical coordinate based on the first score from the respective first data record and a horizontal coordinate based on the second score from the corresponding second data record, as described herein. In some non-limiting embodiments or aspects, the vertical axis and horizontal axis may be switched such that the vertical axis is associated with the second score and the horizontal axis is associated with the first score (and, therefore, the vertical coordinate may be based on the second score and the horizontal coordinate may be based on the first score).

In some non-limiting embodiments or aspects, the first plot may be a scatterplot, as described herein.

In some non-limiting embodiments or aspects, the first plot may be a density plot, as described herein.

As shown in FIG. 2, at step 208, process 200 may include displaying the first plot. For example, model analysis system 102 and/or use device 106 may display the first plot.

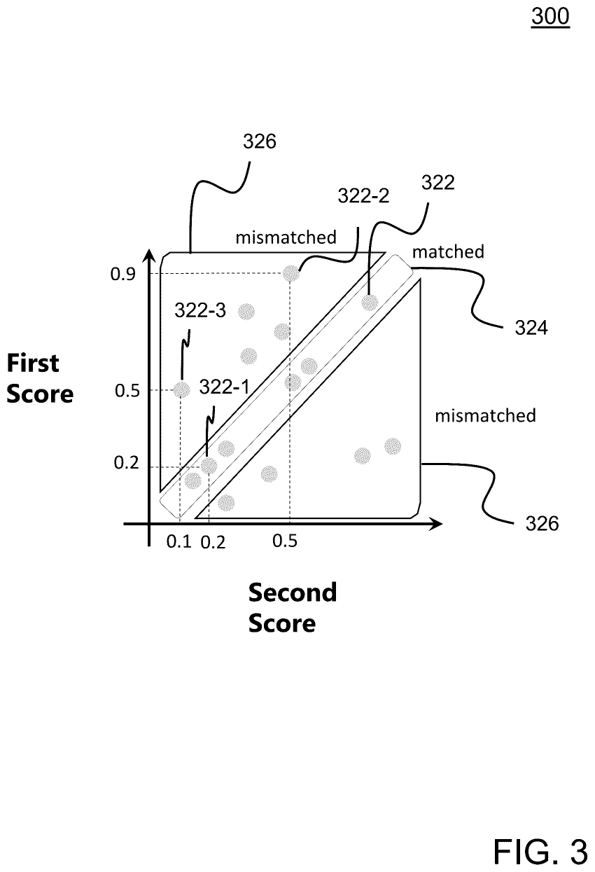

For the purpose of illustration, referring now to FIG. 3 and with continued reference to FIG. 2, shown is an example plot 300 of output scores of a machine learning model in different environments, according to some non-limiting embodiments or aspects. In some non-limiting embodiments or aspects, plot 300 may be displayed by (e.g., included in a graphical user interface (GUI) displayed on) user device 106 and/or model analysis system 102 (e.g., a computing device thereof), as described herein. In some non-limiting embodiments or aspects, plot 300 may be displayed by another system, another device, another group of systems, or another group of devices, separate from or including user device 106 and/or model analysis system 102, as described herein.

As shown in FIG. 3, plot 300 may include a vertical axis associated with a first score (e.g., generated by the machine learning model based on the first data records and/or the first fields thereof from the first environment) and a horizontal axis associated with a second score (e.g., generated by the machine learning model based on the second data records and/or the second fields thereof from the second environment). Each point 322 of the plot may have a vertical coordinate based on the first score from the respective first data record and a horizontal coordinate based on the second score from the corresponding second data record, as described herein. In some non-limiting embodiments or aspects, the vertical axis and horizontal axis may be switched such that the vertical axis is associated with the second score and the horizontal axis is associated with the first score (and, therefore, the vertical coordinate may be based on the second score and the horizontal coordinate may be based on the first score).

In some non-limiting embodiments or aspects, when the first score of a first data record and the second score of the corresponding second data record are substantially equal, a point 322 plotted based on those scores will be substantially along the diagonal line of plot 300 (e.g., in matched area 324). For example, point 322-1 may correspond to the first data record having ID value 1 in Table 1 and the second data record having ID value 1 in Table 2. As such, point 322-1 may have a vertical coordinate of 0.2 and a horizontal coordinate of 0.2 and be located along the diagonal line of plot 300 (e.g., in matched zone 324).

In some non-limiting embodiments or aspects, when the first score of a first data record and the second score of the corresponding second data record are not substantially equal (e.g., are mismatched), a point 322 plotted based on those scores will not be substantially along the diagonal line of plot 300. Instead such a point 322 would be located in one of the mismatched areas 326 (e.g., above or below the diagonal line). For example, point 322-2 may correspond to the first data record having ID value 2 in Table 1 and the second data record having ID value 2 in Table 2. As such, point 322-2 may have a vertical coordinate of 0.9 and a horizontal coordinate of 0.5 and be located above the diagonal line of plot 300 (e.g., in upper mismatched zone 326). For example, point 322-3 may correspond to the first data record having ID value 3 in Table 1 and the second data record having ID value 3 in Table 2. As such, point 322-3 may have a vertical coordinate of 0.5 and a horizontal coordinate of 0.1 and be located above the diagonal line of plot 300 (e.g., in upper mismatched zone 326).

Referring again to FIG. 2, at step 210, process 200 may include generating second plots. For example, model analysis system 102 may generate a plurality of second plots associated with at least a subset of the plurality of features. For example, each respective second plot may be generated based on a respective first field of the plurality of first fields associated with a respective feature of the plurality of features and a respective second field of the plurality of second fields associated with the (same) respective feature.

In some non-limiting embodiments or aspects, each second plot may include a plurality of points (e.g., second points). For example, each respective point may be associated with a respective first data record and the corresponding second data record (e.g., the second data record having an identifier that matches the identifier of the respective first data record).

In some non-limiting embodiments or aspects, each respective point may have at least one coordinate based on the first field associated with the respective feature from the respective first data record and at least one coordinate based on the second field associated with the respective feature from the corresponding second data record. For example, each second plot may include a vertical axis associated with the first field (e.g., from the first data records from the first environment) and a horizontal axis associated with the second field (e.g., from the second data records from the second environment), as described herein. As such, each respective point of the plot may have a vertical coordinate based on the first field from the respective first data record and a horizontal coordinate based on the second field from the corresponding second data record, as described herein. In some non-limiting embodiments or aspects, the vertical axis and horizontal axis may be switched such that the vertical axis is associated with the second field and the horizontal axis is associated with the first field (and, therefore, the vertical coordinate may be based on the second field and the horizontal coordinate may be based on the first field).

In some non-limiting embodiments or aspects, when the first field of a first data record and the second field of the corresponding second data record are substantially equal, a point plotted based on those scores will be substantially along the diagonal line of the plot (e.g., in a matched area, as described herein). When the first field of the first data record and the second field of the corresponding second data record are not substantially equal (e.g., are mismatched), a point plotted based on those scores will not be substantially along the diagonal line of the plot. Instead such a point would be located above or below the diagonal line (e.g., in one of the mismatched areas, as described herein).

In some non-limiting embodiments or aspects, each second plot may be a scatterplot, as described herein.

In some non-limiting embodiments or aspects, each second plot may be a density plot, as described herein.

As shown in FIG. 2, at step 212, process 200 may include displaying the second plots. For example, model analysis system 102 may display the plurality of second plots.

In some non-limiting embodiments or aspects, the second plots may be displayed simultaneously with the first plot. Additionally or alternatively, the second plots may be part of (e.g., at least partially displayed in) the same GUI (and/or accessible in the same window) as the first plot.

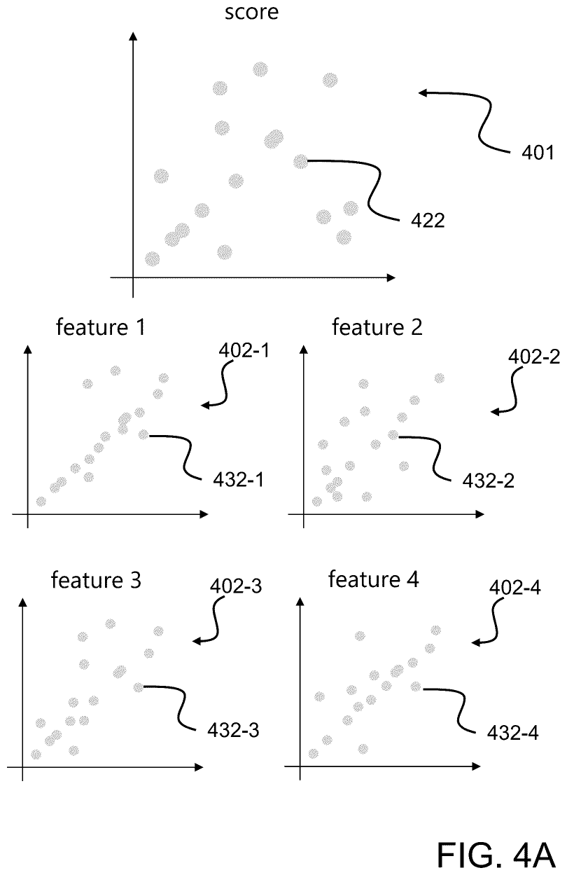

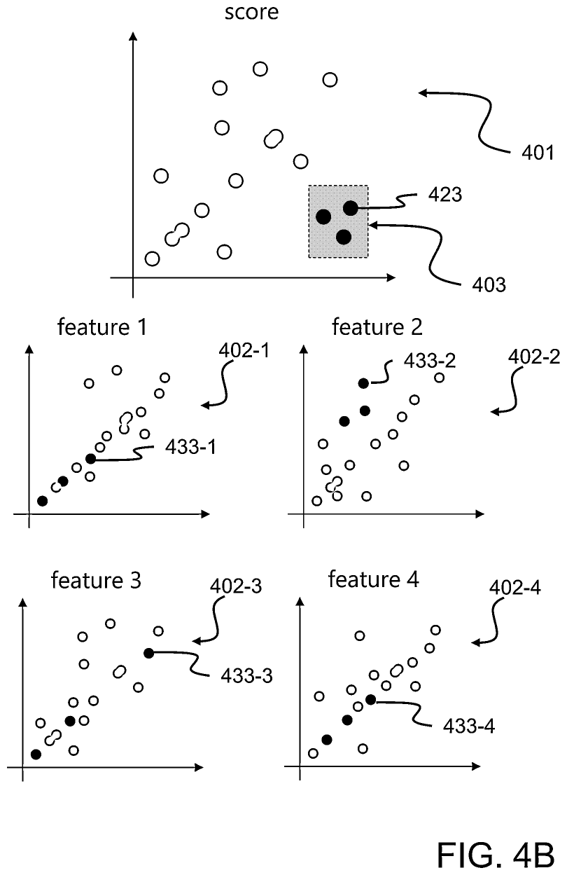

For the purpose of illustration, referring now to FIGS. 4A and 4B and with continued reference to FIG. 2, shown are example plots (e.g., score plot 401 and feature plots 402-1 through 402-4) according to an example implementation of a process for coordinated analysis of output scores and input features of machine learning models in different environments, according to some non-limiting embodiments or aspects. In some non-limiting embodiments or aspects, the plots shown in FIGS. 4A and 4B may be displayed by (e.g., included in a GUI displayed on) user device 106 and/or model analysis system 102 (e.g., a computing device thereof). In some non-limiting embodiments or aspects, the plots shown in FIGS. 4A and 4B may be displayed by another system, another device, another group of systems, or another group of devices, separate from or including user device 106 and/or model analysis system 102.

In some non-limiting embodiments or aspects, score plot 401 may be the same as or similar to a first plot, as described herein (e.g., with reference to steps 206 and 208 of FIG. 2). In some non-limiting embodiments or aspects, each feature plot 402-1 through 402-4 may be the same as or similar to a second plot, as described herein (e.g., with reference to steps 210 and 212 of FIG. 2).

As shown in FIG. 4A, score plot 401 may include a vertical axis, a horizontal axis, and points 422 based on the first score for each first data record and the second score for each second data record, as described herein.

Feature plot 402-1 may be associated with a first feature (e.g., feature 1), as described herein. Feature plot 402-1 may include a vertical axis, a horizontal axis, and points 432-1 based on a first field from each first data record associated with the first feature and a second field from the corresponding second data record associated with the first feature, as described herein.

Feature plot 402-2 may be associated with a second feature (e.g., feature 2), as described herein. Feature plot 402-2 may include a vertical axis, a horizontal axis, and points 432-2 based on a first field from each first data record associated with the second feature and a second field from the corresponding second data record associated with the second feature, as described herein.

Feature plot 402-3 may be associated with a third feature (e.g., feature 3), as described herein. Feature plot 402-3 may include a vertical axis, a horizontal axis, and points 432-3 based on a first field from each first data record associated with the third feature and a second field from the corresponding second data record associated with the third feature, as described herein.

Feature plot 402-4 may be associated with a fourth feature (e.g., feature 4), as described herein. Feature plot 402-4 may include a vertical axis, a horizontal axis, and points 432-4 based on a first field from each first data record associated with the fourth feature and a second field from the corresponding second data record associated with the fourth feature, as described herein.

With continued reference to FIG. 2, in some non-limiting embodiments or aspects, a selection of one or more points in one of the displayed plots may be received (e.g., by user device 106 and/or model analysis system 102). Corresponding points (e.g., associated with the same data records) may be automatically selected (e.g., by user device 106 and/or model analysis system 102) in each other plot (e.g., by highlighting, changing color and/or shading, and/or the like of the corresponding points)

For the purpose of illustration, as shown in FIG. 4B, a selection (e.g., an input indicating a selection, such as a selection box 403, a lasso, a click, a tap, and/or the like) of at least one point 423 in score plot 401 may be received (e.g., by user device 106 and/or model analysis system 102). For example, each selected point 423 may be associated with a respective first data record (e.g., from the first environment) and a respective second data record (e.g., from the second environment). At least one corresponding point 433-1 through 433-4 may be automatically selected (e.g., by user device 106 and/or model analysis system 102) in each feature plot 402-1 through 402-4. For example, each automatically selected corresponding point 433-1 through 433-4 may be associated with the same first data record and second data record as a respective selected point 423.

In some non-limiting embodiments or aspects, a selection (e.g., an input indicating a selection, such as a selection box, a lasso, a click, a tap, and/or the like) of at least one point in one of the features plots 402-1 through 402-4 may be received (e.g., by user device 106 and/or model analysis system 102). For example, each selected point may be associated with a respective first data record (e.g., from the first environment) and a respective second data record (e.g., from the second environment). At least one corresponding point may be automatically selected (e.g., by user device 106 and/or model analysis system 102) in the score plot 401, and/or at least one corresponding point may be automatically selected (e.g., by user device 106 and/or model analysis system 102) in each other feature plot 402-1 through 402-4 (e.g., the corresponding points may be associated with the same first data record and second data record as a respective selected point).

With continued reference to FIG. 2, in some non-limiting embodiments or aspects, the plurality of features may be ranked (e.g., by model analysis system 102 and/or user device 106) based on at least one mismatch metric determined based on the respective first fields of the first data records (e.g., from the first environment) associated with each respective feature and the respective second fields of the second data records (e.g., from the second environment) associated with each respective feature. For example, generating the second plots (e.g., feature plots) may include generating second plots associated with a selected number of the plurality of features based on the ranking of the plurality of features (e.g., generate a selected number of second plots with the greatest mismatch metric and/or the like). Additionally or alternatively, displaying the second plots may include displaying the second plots in order based on the ranking of the plurality of features (e.g., in order of greatest to least mismatch metric).

In some non-limiting embodiments or aspects, the at least one mismatch metric may include at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

In some non-limiting embodiments or aspects, the at least one mismatch metric may include a Pearson correlation metric. Ranking the plurality of features may include determining (e.g., by model analysis system 102 and/or user device 106) a first difference based on the first score for each first data record and the second score for each second data record and/or determining (e.g., by model analysis system 102 and/or user device 106) a plurality of second differences comprising a respective second difference based on the respective first field associated with each respective feature and the respective second field associated with each respective feature. The Pearson correlation metric may be determined (e.g., by model analysis system 102 and/or user device 106) for each respective feature based on the first difference and the respective second difference. For the purpose of illustration, the mismatch metric (Corrᵢ) may be determined based on the following equation:

$${Corr}_{i} = Pearson ( \vert {D}_{1} ( score ) - {D}_{2} ( score ) \vert , \vert {D}_{1} ( {f}_{i} ) - {D}_{2} ( {f}_{i} ) \vert ) ,$$

where D₁ is the set of first data records, D₂ is the set of second data records, score is the score field, fᵢ is the respective field associated with the respective feature, and Pearson is a function for calculating the Pearson correlation coefficient based on the two differences in the equation.

In some non-limiting embodiments or aspects, the at least one metric may include determining (e.g., by model analysis system 102 and/or user device 106) a first difference based on the first score for each first data record and the second score for each second data record and/or determining (e.g., by model analysis system 102 and/or user device 106) a plurality of second differences comprising a respective second difference based on the respective first field associated with each respective feature and the respective second field associated with each respective feature. The first difference may be regressed (e.g., by model analysis system 102 and/or user device 106) onto the plurality of second differences based on the at least one decision tree model to provide at least one of the gain metric, the weight metric, the cover metric, the SHAP metric, or any combination thereof. For example, the at least one decision tree model may include a plurality of decision tree models (e.g., an ensemble of decision tree models). For the purpose of illustration, the at least one (e.g., ensemble) of decision tree model(s) may include an XGBoost model.

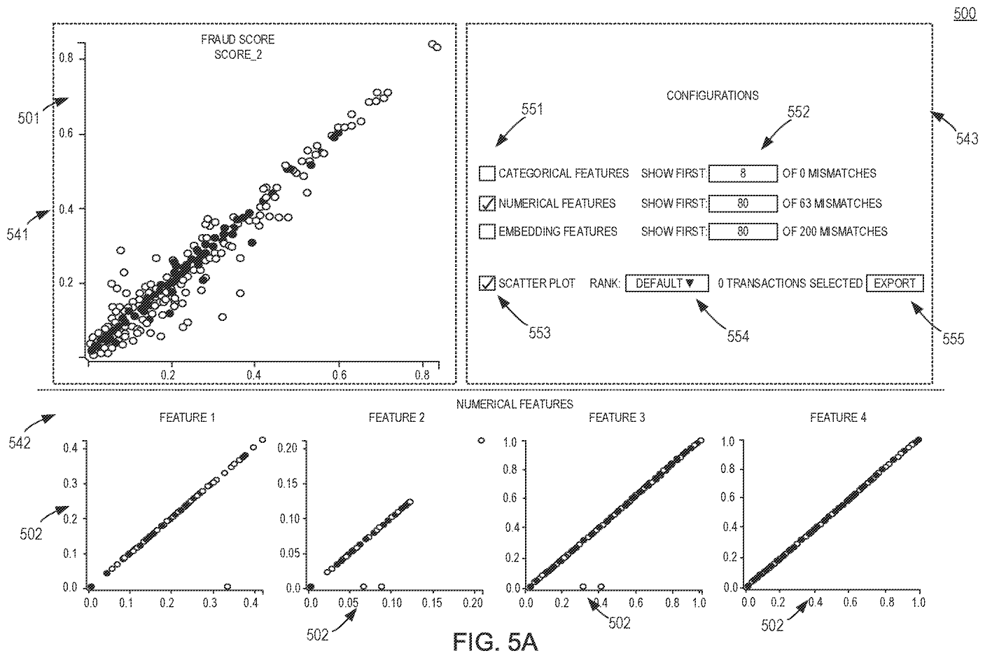

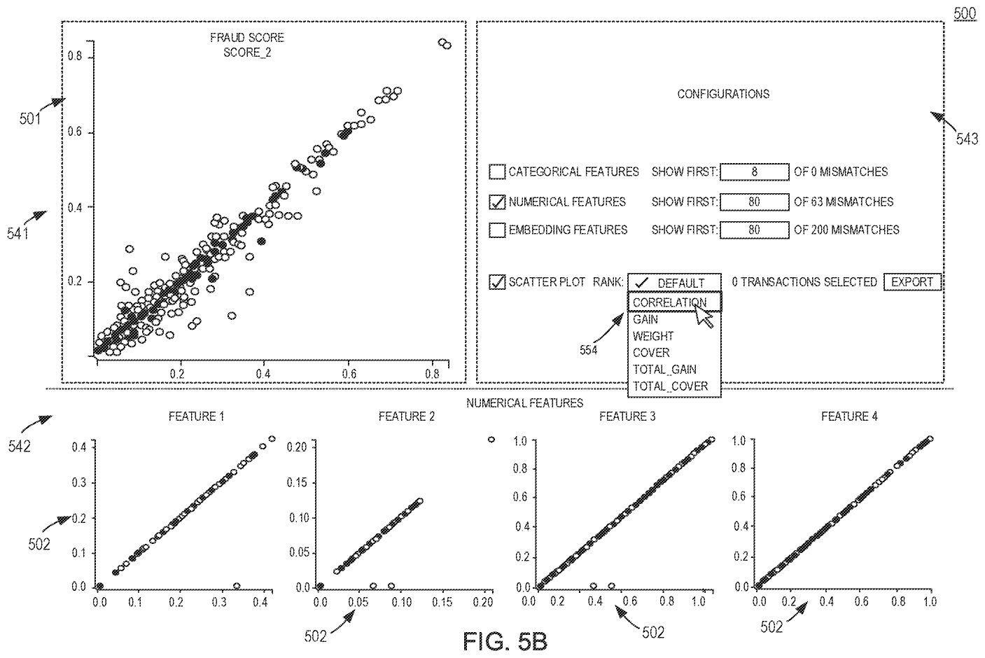

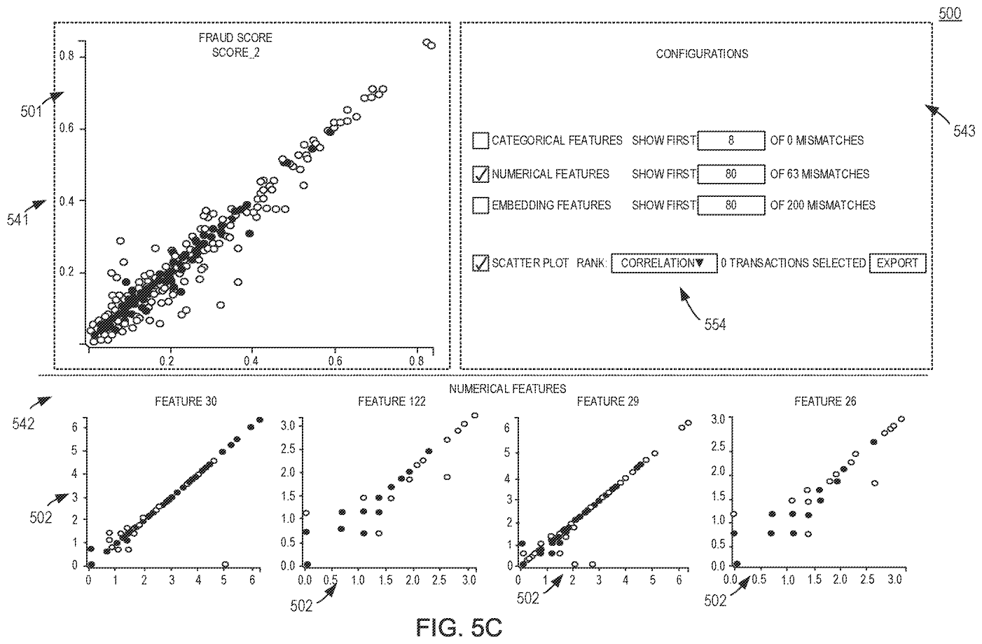

For the purpose of illustration, referring now to FIGS. 5A-5C and with continued reference to FIG. 2, shown is an example GUI 500 according to an example implementation of a process for coordinated analysis of output scores and input features of machine learning models in different environments, according to some non-limiting embodiments or aspects. In some non-limiting embodiments or aspects, GUI 500 may be displayed by user device 106 and/or model analysis system 102 (e.g., a computing device thereof). In some non-limiting embodiments or aspects, GUI 500 may be displayed by another system, another device, another group of systems, or another group of devices, separate from or including user device 106 and/or model analysis system 102.

As shown in FIG. 5A, GUI 500 may include at least one of first area 541, second area 542, and third area 543. For example, first area 541 may include (e.g., have displayed therein) score plot 501 (e.g., a first plot, as described herein). Second area 542 may include (e.g., have displayed therein) a plurality of feature plots 502 (e.g., plurality of second plots, as described herein). Third area 543 may include at least one graphical element for configuring GUI 500 and/or the plots (e.g., score plot 501 and/or feature plots 502) thereof (e.g., configuring the generation, display, and/or ranking of the plots). For example, the graphical elements may include checkboxes 551, textboxes 552, checkbox 553, dropdown menu 554, and/or button 555.

In some non-limiting embodiments or aspects, selecting one or more of checkboxes 551 may cause GUI 500 to display feature plots 502 of a selected number of a respective type (or types) of features (e.g., categorical features, numerical features, and/or embedding features). Unchecking (or leaving unchecked) any of checkboxes 551 may cause GUI 500 to not display the respective type of features. The selected number each type of feature (and therefore the number of corresponding feature plots 502 displayed) may be determined based on a number inputted into the respective textbox 552. For example, as shown in FIG. 5A, the checkbox 551 associated with numerical features is selected, and the selected number in the respective textbox 552 is 80, so GUI 500 may include up to 80 feature plots 502 associated with numerical features. (While only four feature plots are shown in FIG. 5A, the other feature plots 502 may be viewable if GUI 500 is displayed on a larger screen or if a user scrolls down through feature plots 502 displayed in second area 542 of GUI 500).

In some non-limiting embodiments or aspects, selecting checkbox 553 may cause GUI 500 to display score plot 501 and/or feature plots 502 as scatterplots. Unchecking (or leaving unchecked) checkbox 553 may cause GUI 500 to display score plot 501 and/or feature plots 502 as a different type of plot (e.g., density plots and/or the like).

In some non-limiting embodiments or aspects, selecting button 555 may cause GUI 500 (and/or the computing device displaying GUI 500) to export data associated with any selected points (e.g., the data records associated with any selected points) in the plots (e.g., score plot 501 and/or feature plots 502). For example, the exported data may be formatted as tabular data, such as a spreadsheet (e.g., a comma-separated values (CSV file), an Excel file, and/or the like), a table, and/or the like.

In some non-limiting embodiments or aspects, selecting different options in dropdown menu 554 may cause GUI 500 (and/or the computing device displaying GUI 500) to rank the features based on different mismatch metrics and/or display feature plots 502 according to the ranking. For example, as shown in FIG. 5B, a correlation metric (e.g., Pearson correlation metric) may be selected from dropdown menu 554. As shown in FIG. 5C, second plots 502 are reordered and displayed according to the order of the ranking of the features based on the selected correlation metric.

With continued reference to FIG. 2, in some non-limiting embodiments or aspects, the plots may include scatterplots. For example, the first plot (e.g., score plot) may include a first scatterplot and the plurality of second plots (e.g., feature plots) may include a plurality of second scatterplots. In some non-limiting embodiments or aspects, the scatterplots may be converted to another type of plot (e.g., a density plot). For example, model analysis system 102 and/or user device 106 may convert the first scatterplot to a first density plot and/or convert the plurality of second scatterplots to a plurality of second density plots. Additionally or alternatively, model analysis system 102 and/or user device 106 may display the first density plot and/or the second density plots.

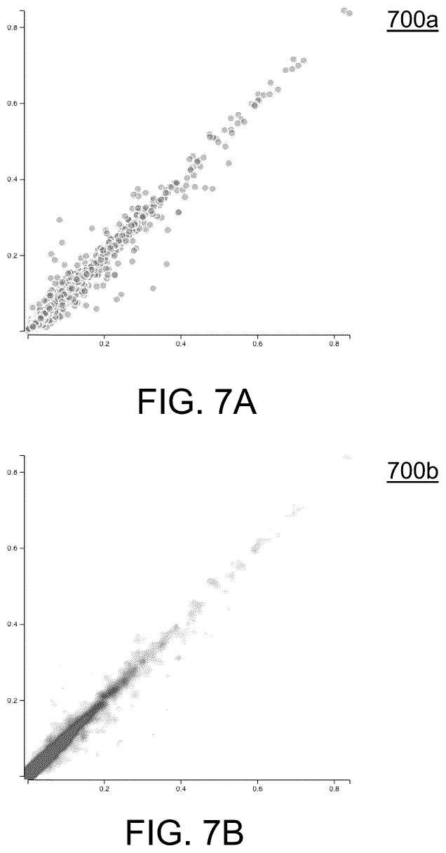

For the purpose of illustration, referring now to FIGS. 7A and 7B and with continued reference to FIG. 2, shown are an example scatterplot 700a and an example density plot 700b, respectively, according to an example implementation of a process for coordinated analysis of output scores and input features of machine learning models in different environments, according to some non-limiting embodiments or aspects. In some non-limiting embodiments or aspects, scatterplot 700a and density plot 700b may be displayed by (e.g., included in a GUI displayed on) user device 106 and/or model analysis system 102 (e.g., a computing device thereof). In some non-limiting embodiments or aspects, scatterplot 700a and density plot 700b may be displayed by another system, another device, another group of systems, or another group of devices, separate from or including user device 106 and/or model analysis system 102.

In some non-limiting embodiments or aspects, model analysis system 102 and/or user device 106 may convert scatterplot 700a to density plot 700b (e.g., in response to an input from a user, such as selection or deselection of a graphical element of a GUI, as described herein).

With continued reference to FIG. 2, the points in each plot may be indexed (e.g., to enable more efficient automatic selection of the corresponding points in the different plots when a point is selected in one of the plots). For example, the points in each plot may be indexed based on quadtree data structures. For example, model analysis system 102 and/or user device 106 may index a plurality of first points of the first plot (e.g., score plot) based on a first quadtree data structure. Additionally or alternatively, model analysis system 102 and/or user device 106 may index a respective plurality of second points of each respective second plot (e.g., feature plot) based on a respective second quadtree data structure.

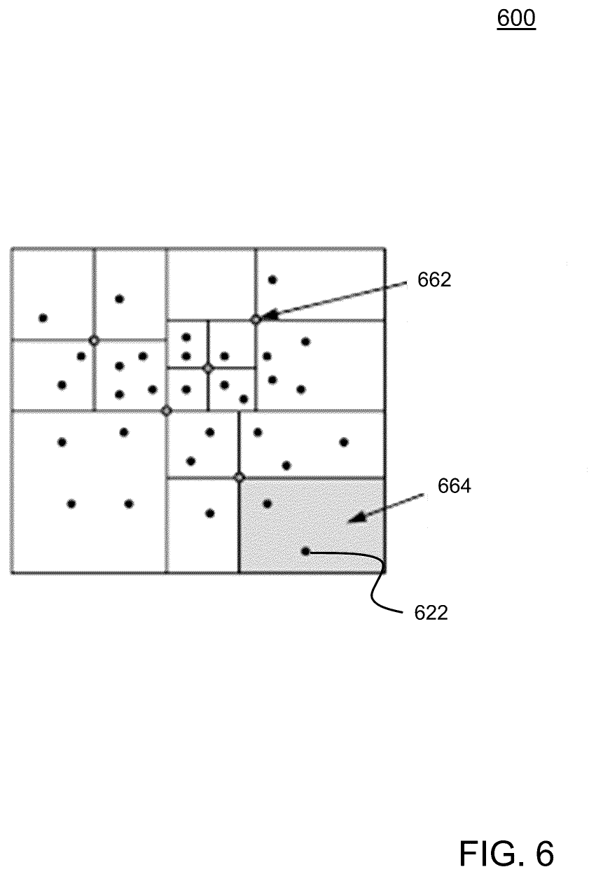

For the purpose of illustration, referring now to FIG. 6 and with continued reference to FIG. 2, shown is an example quadtree 600 according to an example implementation of a process for coordinated analysis of output scores and input features of machine learning models in different environments, according to some non-limiting embodiments or aspects. In some non-limiting embodiments or aspects, quadtree 600 may be implemented by model analysis system 102 (e.g., a computing device thereof) and/or user device 106. In some non-limiting embodiments or aspects, quadtree 600 may be implemented by another system, another device, another group of systems, or another group of devices, separate from or including model analysis system 102 and/or user device 106.

As shown in FIG. 2, points 622 (e.g., of a scatterplot) may be plotted. For example, model analysis system 102 and/or user device 106 may determine the quadtree data structure by dividing the plotted points 622 based on split points 662 to result in leaf nodes 664 (e.g., areas of the plot divided by the split points 662) each having less than a target number of points 622 (e.g., less than five points 622) therein. For example, the entire plot may be referred to as the root of the quadtree data structure. Model analysis system 102 and/or user device 106 may divide the plot (e.g., the root) into four sections (e.g., quads), and each quad may be referred to as a branch of the quadtree data structure. Model analysis system 102 and/or user device 106 may repeatedly divide each branch until the number of points 622 in each of the divisions is less than the target number of points 622. Each division with less than the target number of points 622 may be a leaf node 664. In some non-limiting embodiments or aspects, each point 622 may be indexed based on the leaf node 664 containing the point 622 and/or based on the split points 662 used to result in the leaf node 664.

In some non-limiting embodiments or aspects, each plot (e.g., scatterplot) may have its own quadtree data structure.

In some non-limiting embodiments or aspects, automatic selecting of one of the points 622 (e.g., in response to selection of a corresponding point in another plot, as described herein) may include searching the quadtree data structure of the plot to determine (e.g., identify) the point 622 in the plot.

With continued reference to FIG. 2, data associated with any selected points (e.g., the first data records and/or second data records associated with any selected points) in the plots (e.g., score plot 501 and/or feature plots 502) may be exported (e.g., by model analysis system 102 and/or user device 106). For example, the exported data may be formatted as tabular data, such as a spreadsheet (e.g., a comma-separated values (CSV file), an Excel file, and/or the like), a table, and/or the like.

In some non-limiting embodiments or aspects, the data (e.g., associated with any selected points) may be exported (e.g., by model analysis system 102 and/or user device 106) in response to receiving an input from a user (e.g., via a graphical element of a GUI), as described herein. In some non-limiting embodiments or aspects, data (e.g., associated with any selected points) may be exported automatically (e.g., by model analysis system 102 and/or user device 106) based on the mismatch metric satisfying (e.g., exceeding) a threshold. For example, model analysis system 102 and/or user device 106 may determine the mismatch metric associated with a feature satisfies (e.g., exceeds) a threshold, and model analysis system 102 and/or user device 106 may export data associated with that feature (e.g., first and/or second data records and/or fields thereof) automatically in response to the determination of the mismatch metric satisfying the threshold.

In some non-limiting embodiments or aspects, exporting the data may include communicating (e.g., by model analysis system 102 and/or user device 106) at least one message (e.g., a notification message) to at least one user (e.g., a creator, developer, trainer, and/or user responsible for the deployment of the machine learning model).

In some non-limiting embodiments or aspects, at least one action (e.g., a remediation action) may be taken (e.g., by model analysis system 102 and/or user device 106) based on a mismatch between the first score and the second score, based on a mismatch associated with at least one feature, based on the mismatch metric associated with at least one feature (e.g., the mismatch metric satisfying a threshold), and/or the like. For example, the action(s) may include opening an investigation, reformatting at least one field of the first data records and/or the second data records, exporting data (e.g., as described herein), and/or communicating at least one message, as described herein. For example, opening an investigation may include determining a root cause of the mismatch. For example, the root cause may be determined based on at least one pattern of the points of a plot, and the pattern(s) may depend on the type of feature represented by the plot.

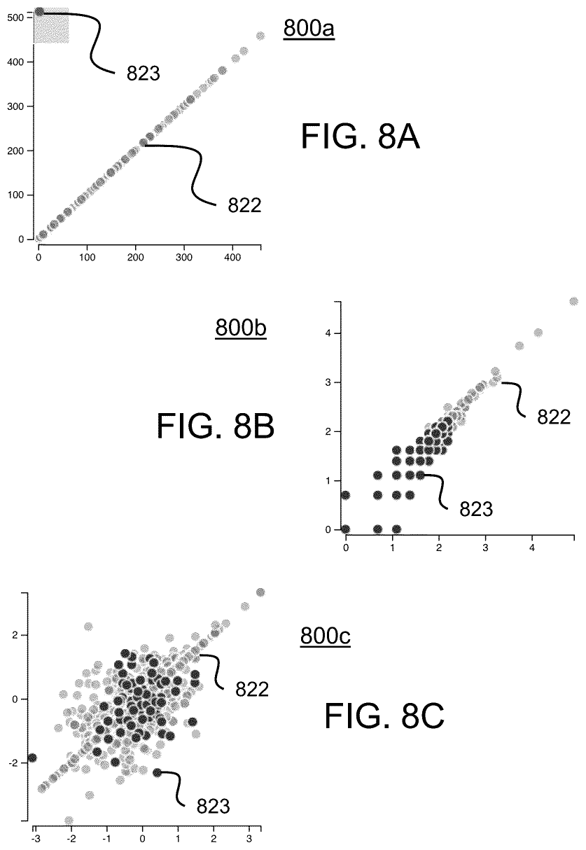

For the purpose of illustration, referring now to FIGS. 8A-8C and with continued reference to FIG. 2, shown are example scatterplots according to example implementations of a process for coordinated analysis of output scores and input features of machine learning models in different environments, according to some non-limiting embodiments or aspects. In some non-limiting embodiments or aspects, the plots shown in FIGS. 8A-8C may be displayed by (e.g., included in a GUI displayed on) user device 106 and/or model analysis system 102 (e.g., a computing device thereof). In some non-limiting embodiments or aspects, the plots shown in FIGS. 8A-8C may be displayed by another system, another device, another group of systems, or another group of devices, separate from or including user device 106 and/or model analysis system 102.

As shown in FIG. 8A, scatterplot 800a may be associated with a categorical feature. A pattern observed in scatterplot 800a may include selected point 823 not being aligned with other points 822 (e.g., the feature has at least one non-aligned point). As such, the root cause of the mismatch in scatterplot 800a may include an extra category included in one of the datasets (e.g., the first data records or the second data records) that is not included in the other one of the datasets.

As shown in FIG. 8B, scatterplot 800b may be associated with a numerical feature (e.g., a transaction velocity metric). A pattern observed in scatterplot 800b may include selected point 823 having larger mismatch metrics than other points 822 (e.g., the feature has greater mismatch on small numerical values). As such, the root cause of the mismatch in scatterplot 800b may include this particular numerical feature (e.g., a transaction velocity metric) being very sensitive when values are small.

As shown in FIG. 8C, scatterplot 800c may be associated with an embedding feature (e.g., an embedding may include a vector representation of raw data, and may have fewer dimensions than the raw data). A pattern observed in scatterplot 800c may include selected points 823 and/or other points 822 having seemingly random amounts of mismatch around the diagonal line (e.g., random values around 0). As such, the root cause of the mismatch in scatterplot 800c may include that a separate model (e.g., an upstream machine learning model responsible for determining the embedding based on the raw data) was not properly initialized and/or refreshed (e.g., a cache was not refreshed).

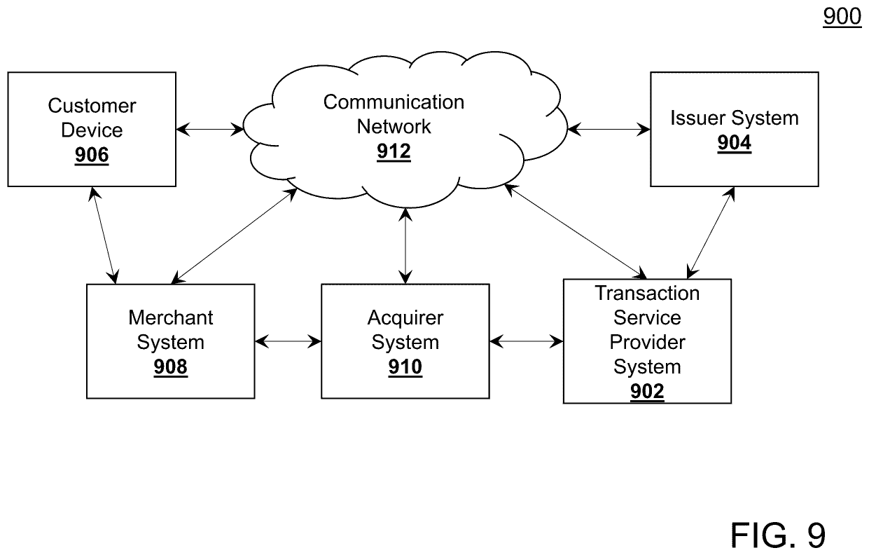

Referring now to FIG. 9, depicted is a diagram of a non-limiting embodiment or aspect of an exemplary environment 900 in which systems, products, and/or methods, as described herein, may be implemented. As shown in FIG. 9, environment 900 may include transaction service provider system 902, issuer system 904, customer device 906, merchant system 908, acquirer system 910, and communication network 912. In some non-limiting embodiments or aspects, each of model analysis system 102, database 104, and/or user device 106 of FIG. 1 may be implemented by (e.g., part of) transaction service provider system 902. In some non-limiting embodiments or aspects, at least one of model analysis system 102, database 104, and/or user device 106 of FIG. 1 may be implemented by (e.g., part of) another system, another device, another group of systems, or another group of devices, separate from or including transaction service provider system 902, such as issuer system 904, customer device 906, merchant system 908, acquirer system 910, and/or the like.

Transaction service provider system 902 may include one or more devices capable of receiving information from and/or communicating information to issuer system 904, customer device 906, merchant system 908, and/or acquirer system 910 via communication network 912. For example, transaction service provider system 902 may include a computing device, such as a server (e.g., a transaction processing server), a group of servers, and/or other like devices. In some non-limiting embodiments or aspects, transaction service provider system 902 may be associated with a transaction service provider as described herein. In some non-limiting embodiments or aspects, transaction service provider system 902 may be in communication with a data storage device, which may be local or remote to transaction service provider system 902. In some non-limiting embodiments or aspects, transaction service provider system 902 may be capable of receiving information from, storing information in, communicating information to, or searching information stored in the data storage device.

Issuer system 904 may include one or more devices capable of receiving information and/or communicating information to transaction service provider system 902, customer device 906, merchant system 908, and/or acquirer system 910 via communication network 912. For example, issuer system 904 may include a computing device, such as a server, a group of servers, and/or other like devices. In some non-limiting embodiments or aspects, issuer system 904 may be associated with an issuer institution as described herein. For example, issuer system 904 may be associated with an issuer institution that issued a credit account, debit account, credit card, debit card, and/or the like to a user associated with customer device 906.

Customer device 906 may include one or more devices capable of receiving information from and/or communicating information to transaction service provider system 902, issuer system 904, merchant system 908, and/or acquirer system 910 via communication network 912. Additionally or alternatively, each customer device 906 may include a device capable of receiving information from and/or communicating information to other customer devices 906 via communication network 912, another network (e.g., an ad hoc network, a local network, a private network, a virtual private network, and/or the like), and/or any other suitable communication technique. For example, customer device 906 may include a client device and/or the like. In some non-limiting embodiments or aspects, customer device 906 may or may not be capable of receiving information (e.g., from merchant system 908 or from another customer device 906) via a short-range wireless communication connection (e.g., an NFC communication connection, an RFID communication connection, a Bluetooth® communication connection, a Zigbee® communication connection, and/or the like), and/or communicating information (e.g., to merchant system 908) via a short-range wireless communication connection.

Merchant system 908 may include one or more devices capable of receiving information from and/or communicating information to transaction service provider system 902, issuer system 904, customer device 906, and/or acquirer system 910 via communication network 912. Merchant system 908 may also include a device capable of receiving information from customer device 906 via communication network 912, a communication connection (e.g., an NFC communication connection, an RFID communication connection, a Bluetooth® communication connection, a Zigbee® communication connection, and/or the like) with customer device 906, and/or the like, and/or communicating information to customer device 906 via communication network 912, the communication connection, and/or the like. In some non-limiting embodiments or aspects, merchant system 908 may include a computing device, such as a server, a group of servers, a client device, a group of client devices, and/or other like devices. In some non-limiting embodiments or aspects, merchant system 908 may be associated with a merchant as described herein. In some non-limiting embodiments or aspects, merchant system 908 may include one or more client devices. For example, merchant system 908 may include a client device that allows a merchant to communicate information to transaction service provider system 902. In some non-limiting embodiments or aspects, merchant system 908 may include one or more devices, such as computers, computer systems, and/or peripheral devices capable of being used by a merchant to conduct a transaction with a user. For example, merchant system 908 may include a POS device and/or a POS system.

Acquirer system 910 may include one or more devices capable of receiving information from and/or communicating information to transaction service provider system 902, issuer system 904, customer device 906, and/or merchant system 908 via communication network 912. For example, acquirer system 910 may include a computing device, a server, a group of servers, and/or the like. In some non-limiting embodiments or aspects, acquirer system 910 may be associated with an acquirer as described herein.

Communication network 912 may include one or more wired and/or wireless networks. For example, communication network 912 may include a cellular network (e.g., a long-term evolution (LTE®) network, a third generation (5G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 9 are provided as an example. There may be additional systems, devices, and/or networks; fewer systems, devices, and/or networks; different systems, devices, and/or networks; and/or differently arranged systems, devices, and/or networks than those shown in FIG. 9. Furthermore, two or more systems or devices shown in FIG. 9 may be implemented within a single system or device, or a single system or device shown in FIG. 9 may be implemented as multiple, distributed systems or devices. Additionally or alternatively, a set of systems (e.g., one or more systems) or a set of devices (e.g., one or more devices) of environment 900 may perform one or more functions described as being performed by another set of systems or another set of devices of environment 900.

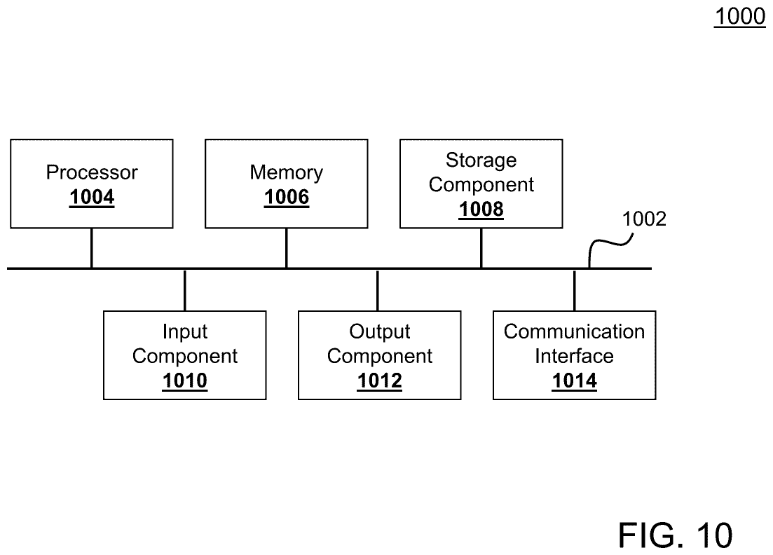

Referring now to FIG. 10, shown is a diagram of example components of a device 1000 according to non-limiting embodiments or aspects. Device 1000 may correspond to model analysis system 102, database(s) 104, and/or user device 106 of FIG. 1 and/or transaction service provider system 902, issuer system 904, customer device 906, merchant system 908, acquirer system 910, and/or communication network 912 of FIG. 9, as examples. In some non-limiting embodiments or aspects, such systems or devices may include at least one device 1000 and/or at least one component of device 1000. The number and arrangement of components shown are provided as an example. In some non-limiting embodiments or aspects, device 1000 may include additional components, fewer components, different components, or differently arranged components than those shown in FIG. 10. Additionally or alternatively, a set of components (e.g., one or more components) of device 1000 may perform one or more functions described as being performed by another set of components of device 1000.

As shown in FIG. 10, device 1000 may include a bus 1002, a processor 1004, memory 1006, a storage component 1008, an input component 1010, an output component 1012, and a communication interface 1014. Bus 1002 may include a component that permits communication among the components of device 1000. In some non-limiting embodiments or aspects, processor 1004 may be implemented in hardware, firmware, or a combination of hardware and software. For example, processor 1004 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1006 may include random access memory (RAM), read only memory (ROM), and/or another type of dynamic or static storage device (e.g., flash memory, magnetic memory, optical memory, etc.) that stores information and/or instructions for use by processor 1004.

With continued reference to FIG. 10, storage component 1008 may store information and/or software related to the operation and use of device 1000. For example, storage component 1008 may include a hard disk (e.g., a magnetic disk, an optical disk, a magneto-optic disk, a solid state disk, etc.) and/or another type of computer-readable medium. Input component 1010 may include a component that permits device 1000 to receive information, such as via user input (e.g., a touch screen display, a keyboard, a keypad, a mouse, a button, a switch, a microphone, etc.). Additionally or alternatively, input component 1010 may include a sensor for sensing information (e.g., a global positioning system (GPS) component, an accelerometer, a gyroscope, an actuator, etc.). Output component 1012 may include a component that provides output information from device 1000 (e.g., a display, a speaker, one or more light-emitting diodes (LEDs), etc.). Communication interface 1014 may include a transceiver-like component (e.g., a transceiver, a separate receiver and transmitter, etc.) that enables device 1000 to communicate with other devices, such as via a wired connection, a wireless connection, or a combination of wired and wireless connections. Communication interface 1014 may permit device 1000 to receive information from another device and/or provide information to another device. For example, communication interface 1014 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1000 may perform one or more processes described herein. Device 1000 may perform these processes based on processor 1004 executing software instructions stored by a computer-readable medium, such as memory 1006 and/or storage component 1008. A computer-readable medium may include any non-transitory memory device. A memory device includes memory space located inside of a single physical storage device or memory space spread across multiple physical storage devices. Software instructions may be read into memory 1006 and/or storage component 1008 from another computer-readable medium or from another device via communication interface 1014. When executed, software instructions stored in memory 1006 and/or storage component 1008 may cause processor 1004 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method for coordinated analysis of output scores and input features of machine learning models in different environments, comprising:
receiving, with at least one processor, a plurality of first data records, each first data record of the plurality of first data records comprising a plurality of first fields associated with a plurality of features and a first score field associated with a first score generated by a machine learning model based on the plurality of first fields;
receiving, with at least one processor, a plurality of second data records, each second data record of the plurality of second data records comprising a plurality of second fields associated with the plurality of features and a second score field associated with a second score generated by the machine learning model based on the plurality of second fields;
generating, with at least one processor, a first plot based on the first score for each first data record of the plurality of first data records and the second score for each second data record of the plurality of second data records;
displaying, with at least one processor, the first plot;
generating, with at least one processor, a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and
displaying, with at least one processor, the plurality of second plots.

2. The method of claim 1, further comprising:
ranking, with at least one processor, the plurality of features based on at least one mismatch metric determined based on the respective first field associated with each respective feature and the respective second field associated with each respective feature,
wherein generating the plurality of second plots comprises generating the plurality of second plots associated with a selected number of the plurality of features based on the ranking of the plurality of features, and
wherein displaying the plurality of second plots comprises displaying the plurality of second plots in order based on the ranking of the plurality of features.

3. The method of claim 2, wherein the at least one mismatch metric comprises at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

4. The method of claim 3, wherein the at least one metric comprises the Pearson correlation metric, and wherein ranking the plurality of features comprises:
determining a first difference based on the first score for each first data record and the second score for each second data record;
determining a plurality of second differences comprising a respective second difference based on the respective first field associated with each respective feature and the respective second field associated with each respective feature; and
determining the Pearson correlation metric for each respective feature based on the first difference and the respective second difference.

5. The method of claim 3, wherein ranking the plurality of features comprises:
determining a first difference based on the first score for each first data record and the second score for each second data record;
determining a plurality of second differences comprising a respective second difference based on the respective first field associated with each respective feature and the respective second field associated with each respective feature; and
regressing the first difference onto the plurality of second differences based on the at least one decision tree model to provide at least one of the gain metric, the weight metric, the cover metric, the SHAP metric, or any combination thereof.

6. The method of claim 1, further comprising:
receiving, with at least one processor, a selection of a first point in the first plot associated with a respective first data record of the plurality of first data records and a respective second data record of the plurality of second data records; and
automatically selecting, with at least one processor, a respective second point in each second plot of the plurality of second plots associated with the respective first data record and the respective second data record.

7. The method of claim 1, further comprising:
receiving, with at least one processor, a selection of a second point in one of the plurality of second plots associated with a respective first data record of the plurality of first data records and a respective second data record of the plurality of second data records;
automatically selecting, with at least one processor, a first point in the first plot associated with the respective first data record and the respective second data record; and
automatically selecting, with at least one processor, a respective second point associated with the respective first data record and the respective second data record in each second plot of the plurality of second plots other than the one of the plurality of second plots.

8. The method of claim 1, wherein the first plot comprises a first scatterplot and the plurality of second plots comprises a plurality of second scatterplots, the method further comprising:
converting, with at least one processor, the first scatterplot to a first density plot;
converting, with at least one processor, the plurality of second scatterplots to a plurality of second density plots;
displaying, with at least one processor, the first density plot; and
displaying, with at least one processor, the plurality of second density plots.

9. The method of claim 1, further comprising:
indexing, with at least one processor, a plurality of first points of the first plot based on a first quadtree data structure; and
indexing, with at least one processor, a respective plurality of second points of each respective second plot of the plurality of second plots based on a respective second quadtree data structure.

10. The method of claim 1, wherein the plurality of first data records are from a first environment,
wherein the plurality of second data records are from a second environment different than the first environment, and
wherein each respective first data record of the plurality of first data records has a corresponding second data record of the plurality of second data records.

11. The method of claim 10, wherein the first environment comprises an offline environment, and wherein the second environment comprises an online environment.

12. A system for coordinated analysis of output scores and input features of machine learning models in different environments, comprising:
at least one processor; and
at least one non-transitory computer readable medium comprising one or more instructions that, when executed by the at least one processor, cause the at least one processor to:
receive a plurality of first data records, each first data record of the plurality of first data records comprising a plurality of first fields associated with a plurality of features and a first score field associated with a first score generated by a machine learning model based on the plurality of first fields;
receive a plurality of second data records, each second data record of the plurality of second data records comprising a plurality of second fields associated with the plurality of features and a second score field associated with a second score generated by the machine learning model based on the plurality of second fields;
generate a first plot based on the first score for each first data record of the plurality of first data records and the seconds score for each second data record of the plurality of second data records;
display the first plot;
generate a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and
display the plurality of second plots.

13. The system of claim 12, wherein the one or more instructions, when executed by the at least one processor, cause the at least one processor to:
rank the plurality of features based on at least one mismatch metric determined based on the respective first field associated with each respective feature and the respective second field associated with each respective feature,
wherein generating the plurality of second plots comprises generating the plurality of second plots associated with a selected number of the plurality of features based on the ranking of the plurality of features, and
wherein displaying the plurality of second plots comprises displaying the plurality of second plots in order based on the ranking of the plurality of features.

14. The system of claim 13, wherein the at least one mismatch metric comprises at least one of a correlation metric, a Pearson correlation metric, a gain metric determined based on at least one decision tree model, a weight metric determined based on the at least one decision tree model, a cover metric determined based on the at least one decision tree model, a SHapley Additive explanations (SHAP) metric determined based on the at least one decision tree model, or any combination thereof.

15. The system of claim 14, wherein the at least one metric comprises the Pearson correlation metric, and wherein ranking the plurality of features comprises:
determining a first difference based on the first score for each first data record and the second score for each second data record;
determining a plurality of second differences comprising a respective second difference based on the respective first field associated with each respective feature and the respective second field associated with each respective feature; and
determining the Pearson correlation metric for each respective feature based on the first difference and the respective second difference.

16. The system of claim 14, wherein ranking the plurality of features comprises:
determining a first difference based on the first score for each first data record and the second score for each second data record;
determining a plurality of second differences comprising a respective second difference based on the respective first field associated with each respective feature and the respective second field associated with each respective feature; and
regressing the first difference onto the plurality of second differences based on the at least one decision tree model to provide at least one of the gain metric, the weight metric, the cover metric, the SHAP metric, or any combination thereof.

17. The system of claim 12, wherein the one or more instructions, when executed by the at least one processor, cause the at least one processor to:
receive a selection of a first point in the first plot associated with a respective first data record of the plurality of first data records and a respective second data record of the plurality of second data records; and
automatically select a respective second point in each second plot of the plurality of second plots associated with the respective first data record and the respective second data record.

18. The system of claim 12, wherein the one or more instructions, when executed by the at least one processor, cause the at least one processor to:
receive a selection of a second point in one of the plurality of second plots associated with a respective first data record of the plurality of first data records and a respective second data record of the plurality of second data records;
automatically select a first point in the first plot associated with the respective first data record and the respective second data record; and
automatically select a respective second point associated with the respective first data record and the respective second data record in each second plot of the plurality of second plots other than the one of the plurality of second plots.

19. The method of claim 1, wherein the plurality of first data records are from a first environment,
wherein the plurality of second data records are from a second environment different than the first environment,
wherein each respective first data record of the plurality of first data records has a corresponding second data record of the plurality of second data records, and
wherein the first environment comprises an offline environment and the second environment comprises an online environment.

20. A computer program product, the computer program product comprising at least one non-transitory computer-readable medium comprising one or more instructions that, when executed by at least one processor, cause the at least one processor to:
receive a plurality of first data records, each first data record of the plurality of first data records comprising a plurality of first fields associated with a plurality of features and a first score field associated with a first score generated by a machine learning model based on the plurality of first fields;
receive a plurality of second data records, each second data record of the plurality of second data records comprising a plurality of second fields associated with the plurality of features and a second score field associated with a second score generated by the machine learning model based on the plurality of second fields;
generate a first plot based on the first score for each first data record of the plurality of first data records and the seconds score for each second data record of the plurality of second data records;
display the first plot;
generate a plurality of second plots associated with at least a subset of the plurality of features, each respective second plot of the plurality of second plots generated based on a respective first field of the plurality of first fields associated with a respective feature of the plurality of features and a respective second field of the plurality of second fields associated with the respective feature; and
display the plurality of second plots.
